(19) United States
(12) Patent Application Publication
(10) Pub. No.: US 2004/0142601 A1
(43) Pub. Date: Jul. 22, 2004

(54) Adapter wall plate assembly with integrated electrical function

(76) Inventor: Daniel V. H. Luu, Houston, TX (US)

Correspondence Address: DICKSTEIN SHAPIRO MORIN & OSHINSKY LLP, 2101 L STREET NW, WASHINGTON, DC, 20037-1526, US

(21) Appl. No.: 10/694,786

(22) Filed: Oct. 29, 2003

Related U.S. Application Data
(60) Provisional application No. 60/421,814, filed on Oct. 29, 2002.

(51) Int. Cl. H01R 25/00

(52) U.S. Cl. 439/652

(57) ABSTRACT

A wall plate assembly includes at least one electrical functions incorporated directly into the assembly, while also serving as a wall plate or wall plate cover for an electrical wall outlet. The wall plate assembly also has an opening sized and shaped to fit around at least one receptacle of the wall outlet, a male plug so that the wall plate assembly can be plugged into one receptacle of the wall outlet to provide continuous power to the electrical function incorporated in the assembly, and at least one plug receptacle for allowing additional electrical devices to access electrical current at the same wall outlet. The opening and the male plug are aligned so that the plug prongs can be inserted into an upper outlet receptacle of a wall outlet while a lower outlet receptacle is exposed through and framed by the opening.

This application claims the benefit of U.S. Provisional Application Serial No. 60/421,814, filed on Oct. 29, 2002, the entire contents of which are incorporated herein by reference.

### BACKGROUND OF THE INVENTION

1. Field of the Invention

The present invention relates to a wall plate assembly having at least one electrical function integrally formed therewith, without reducing the number of electrical outlet receptacles available for use by other electrical devices.

2. Brief Description of the Related Art

Electrical wall outlets typically consist of two electric receptacles. It may be desirable to plug in certain compact electrical devices and to leave them in place for continuous operation. Such devices include night lights, timers, alarms or surge protectors, for example. When these items are in use, however, one of the two outlet receptacles is continually occupied, leaving only one open receptacle.

The disadvantage of leaving an electrical device plugged into an outlet has been addressed by incorporating such devices into a wall plate adjacent to the outlet receptacles. Examples of such devices include the night light wall plates disclosed in U.S. Pat. Nos. 5,670,776 to Rothbaum, 5,816,682 to Marischen, and 5,660,459 to Appelberg. These lighted wall plates, however, must be installed with a direct electrical connection to the existing wiring system. Thus, installation of such devices is relatively complicated and requires the installer to work with the electrical wiring connecting to the outlet receptacles, which potentially exposes an inexperienced installer to dangerous situations. Alternatively, such devices may be powered by either a battery or a photoluminescent material, both of which have limited lives and limited capabilities.

Another type of wall plate assembly having an electrical function provided therein is disclosed in U.S. Pat. No. 6,297,450 to Yu, and U.S. Pat. No. 5,384,428 to Luu. This type of assembly includes a wall plate or wall plate cover which have receptacle covers to be aligned over the outlet receptacles of the wall outlet. The receptacle covers have electrical contacts at the periphery of the prong holes of the receptacle covers so that when an electrical device is plugged into the outlet receptacle through the receptacle cover, the prongs of the plug contact the electrical contacts in the receptacle cover and provide power from the wall outlet to power the electrical function integrated into the wall plate. Thus, the integrated wall plate function is only operative when an electrical device is plugged into the wall outlet through the wall plate receptacle cover. Another disadvantage with having the receptacle covers over the wall outlet receptacles is that this reduces the depth to which prongs of the plug are inserted into the wall outlet.

It would be desirable to provide electrical devices with a means for obtaining power from an electrical outlet without diminishing the capacity of the wall outlet to accommodate additional electrical devices. In addition, it would be desirable to provide an easily installed wall plate providing an adjunct electrical device on the wall plate, where the wall plate device does not require direct wiring, and is not limited to devices that are battery driven or have only photoluminescent capabilities. It would be further desirable to provide an electrical function which does not require a plug to be inserted into one of the receptacles to be operative, and also which does not prevent a plug from fully engaging an electrical outlet to access current from the wall outlet.

### BRIEF SUMMARY OF THE INVENTION

One aspect of the present invention provides a wall plate assembly in which electrical devices may be integrally incorporated into the assembly without reducing the number of available outlet receptacles in a wall outlet.

Another aspect of the invention provides an electrical function integrally incorporated into a wall plate assembly and which is operable without requiring another electrical device to be plugged into or through the wall plate assembly.

A further aspect of the invention enables an electrical function which is integrally incorporated into a wall plate assembly to be supplied with electrical current without requiring that any part of the assembly be directly wired into the electrical circuit behind the wall outlet, and without relying on batteries or photoluminescent materials.

The present invention includes a wall plate assembly having at least one electrical function incorporated directly into the assembly, while also serving as a wall plate or wall plate cover for an electrical wall outlet. The wall plate assembly also has an opening sized and shaped to fit around at least one receptacle of the wall outlet, a male plug so that the wall plate assembly can be plugged into one receptacle of the wall outlet to provide continuous power to the electrical function incorporated in the assembly, and at least one plug receptacle for allowing additional electrical devices to access electrical current at the same wall outlet.

Other features and advantages of the present invention will become apparent from the following description of the invention which refers to the accompanying drawings.

### BRIEF DESCRIPTION OF THE DRAWINGS

FIG. 1 shows an exemplary embodiment of the wall plate assembly in accordance with the present invention;

FIG. 2 is a side view of the wall plate assembly of FIG. 1;

FIG. 3 shows the wall plate assembly of FIG. 1 as installed on a wall outlet;

FIG. 4 shows a second exemplary embodiment of the wall plate assembly in accordance with the present invention;

FIG. 5 is a side view of the wall plate assembly of FIG. 4;

FIG. 6 is an exploded view of the wall plate assembly of FIG. 4 over a standard duplex wall outlet;

FIG. 7 shows a third exemplary embodiment of a wall plate assembly in accordance with the present invention;

FIG. 8 is an exploded view of the wall plate assembly of FIG. 7 over a GFCI wall outlet;

FIG. 9 shows a fourth exemplary embodiment of a wall plate assembly in accordance with the present invention;

FIG. 10 shows a fifth exemplary embodiment of a wall plate assembly in accordance with the present invention;

FIG. 11 shows a sixth exemplary embodiment of a wall plate assembly in accordance with the present invention; and

FIG. 12 shows a seventh exemplary embodiment of a wall plate assembly in accordance with the present invention.

### DETAILED DESCRIPTION OF THE INVENTION

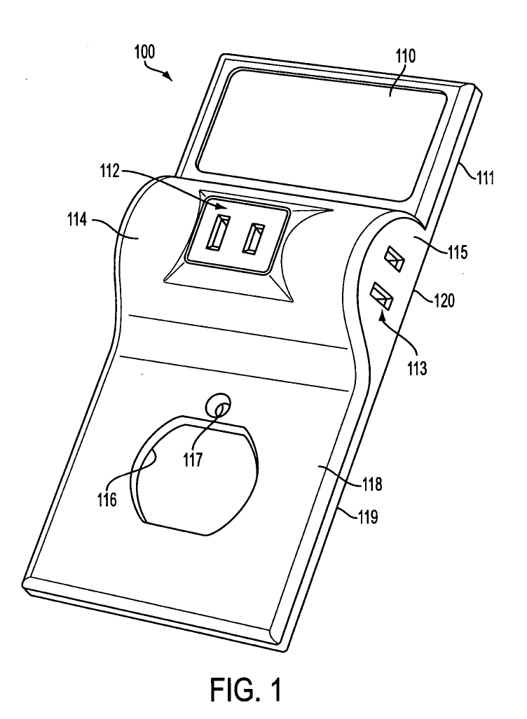

A first exemplary embodiment of the present invention is shown in FIG. 1, in which the assembly 100 includes a wall plate 118 having an electroluminescent panel night light 110 integrally formed in an upper portion 111 thereof, an opening 116 in the lower portion thereof, wherein the opening 116 is sized and shaped to frame an outlet receptacle. The middle portion 120 of the wall plate 118 includes at least one plug receptacle 112, 113 on the top surface 114 and/or side surfaces 115 thereof

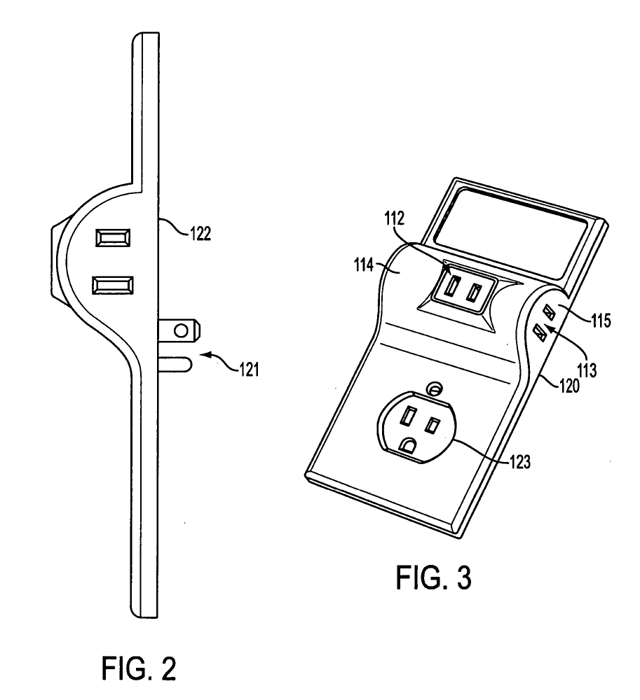

As seen in FIG. 2, a male plug 121 including live, neutral, and optionally, ground prongs such as those provided on a standard plug protrude from the back surface 122 of the wall plate 118. The male plug 121 are aligned with the opening 116 so that the plug prongs can be inserted into one receptacle of a wall outlet while the other outlet receptacle is framed by the opening 116. The wall plate 118 serves as a substitute for a conventional wall plate and is secured to the face of a wall outlet by affixing a screw through the hole 117 provided for this purpose, as shown in FIG. 3, with the plug 121 inserted into an upper receptacle of a wall outlet, and the opening 116 framing the lower receptacle 123 of the wall outlet.

In the embodiment shown in FIGS. 1-3, three additional plug receptacles 112, 113 (third receptacle not shown) are provided in the middle portion 120 of the wall plate 118, with receptacle 112 located on the top surface 114, receptacle 113 located on one side surface 115, and another receptacle (not shown) provided on the other side surface (parallel to and opposing side surface 115 but not shown in the drawings).

Operation of each of the electroluminescent panel night light 110 and any electrical device plugged into the plug receptacles 112, 113 provided in the middle portion 120 of the wall plate 118 is effected by supplying electrical current drawn through the plug 121 inserted into an outlet receptacle of the wall outlet. The lower receptacle 123 of the wall outlet remains available to receive an electrical plug of another electrical device, thus enabling such device to access electrical current through outlet receptacle 123 without interference from or interfering with the electrical function of the night light 110.

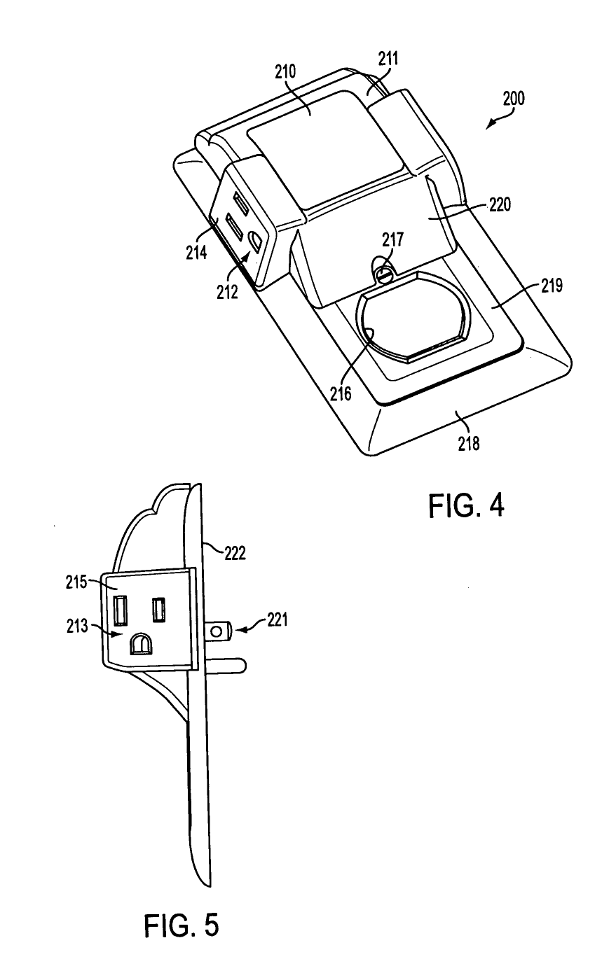

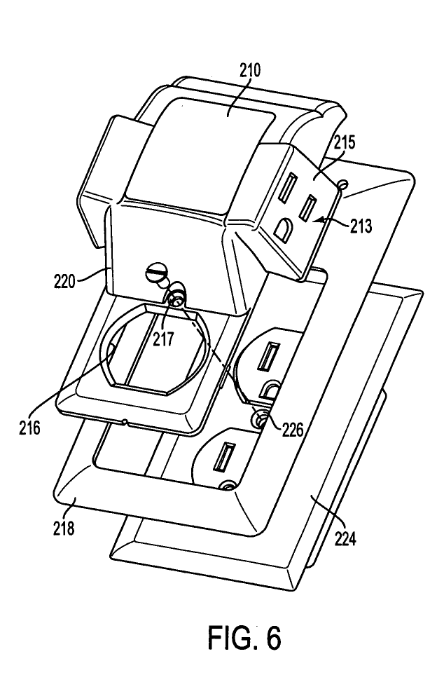

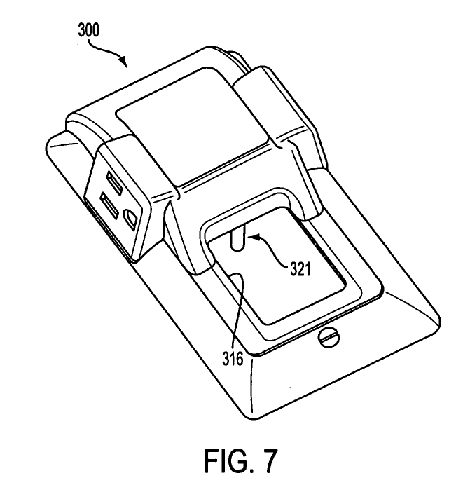

Another exemplary embodiment of the invention is illustrated in FIGS. 4-6, in which the wall plate assembly 200 is formed as a wall plate cover rather than a wall plate as described in the embodiment discussed above with reference to FIGS. 1-3. In particular, this embodiment includes a frame 218 provided around the main housing 220 of the assembly 200. The frame 218 is slightly curved around its peripheral edges, and forms a space under the frame 218 so that a wall plate 224 already affixed around a wall outlet can fit in the space under and be covered by the assembly 200, as illustrated in FIG. 6.

On the other hand, the wall plate assembly 200 is similar to the wall plate assembly 100 of FIGS. 1-3, in that wall plate assembly 200 includes an electrical function incorporated into an upper portion 211 thereof, an opening 216 in a lower portion 219 thereof for being fitted around an outlet receptacle of a wall outlet, additional plug receptacles 212, 213 on side surfaces 214, 215, respectively, provided on housing 220, and a male plug 221 protruding from the back surface 222 of the assembly 200. The assembly 200 is secured to the existing wall plate 224 and hence the wall outlet by removing the screw securing the wall plate 224 to the wall outlet, plugging in the plug 221 into the upper outlet receptacle in the wall outlet, and inserting the screw into the hole 217, and through the original screw hole 226 in the wall plate 224, to secure both the wall plate 224 and the assembly 200 to the wall outlet.

As in the assembly 100, the electrical function provided in assembly 200 is also a night light 210. In this example, the shape of the housing 220 provides more space underneath than provided in the wall plate 118 in FIG. 1. This allows more components and complicated circuitry to be placed therein. For example, the night light 210 can be an electroluminescent light, similarly to the night light 110 in FIG. 1, but may also be formed to use a fluorescent light, an LED light, or an incandescent light, since more room is provided under housing 220 for light bulbs and the like. Optionally, the contour of wall plate 118 in the assembly 100 may be modified to similarly accommodate other types of night lights.

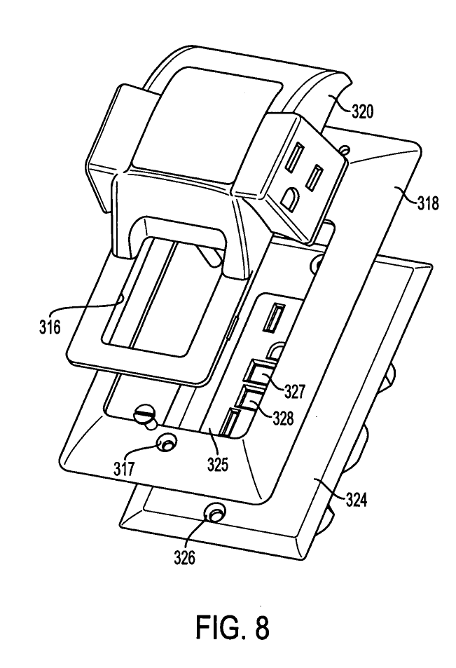

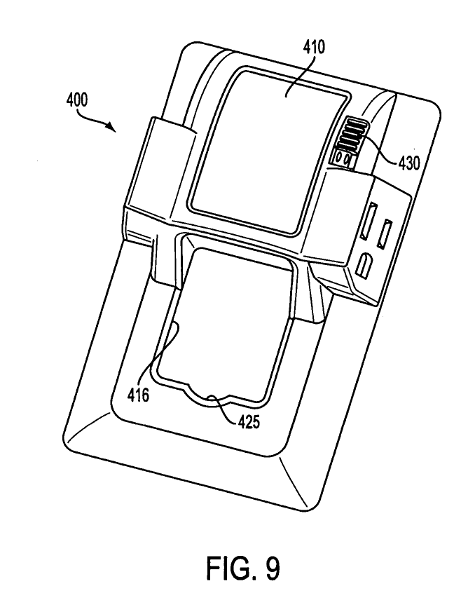

In each of the embodiments shown in FIGS. 1-6, the opening 116, 216 are sized and shaped to accommodate an outlet receptacle in a standard duplex wall outlet. FIG. 7 shows a wall plate assembly 300 which is very similar to the wall plate assembly 200 of FIGS. 4-6, except that the opening 316 is sized and shaped to accommodate the lower portion and receptacle of a GFCI wall outlet 325 or a decor or modern style wall outlet, as illustrated in FIG. 8. In this embodiment, opening 316 should be large enough to enable access to the test and reset buttons 327 and 328 of the wall outlet 325. The wall plate assembly 300 covers an existing wall plate 324, and is affixed to the outlet 325 by inserting the plug 321 provided on the back surface of the assembly into the upper receptacle of the outlet 325, and securing a screw through hole 317 in the assembly frame 318 and hole 326 in the existing wall plate 324.

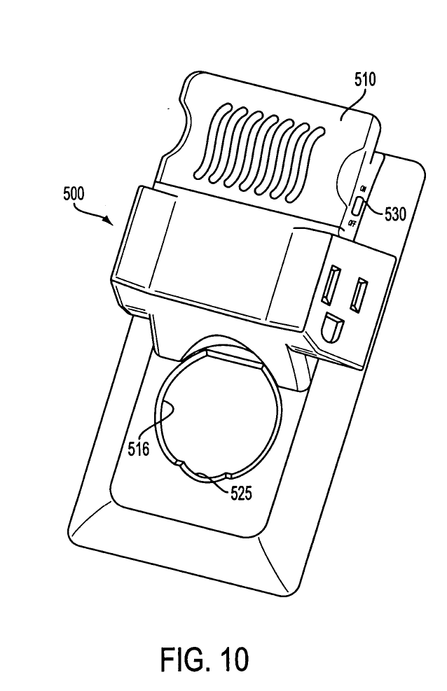

FIG. 9 shows another exemplary embodiment of the wall plate assembly 400 similar to the assembly 300 shown in FIGS. 7-8, except that opening 416 in the assembly 400 is enlarged along the bottom edge by an indent 425. The indent 425 feature accommodates heavy duty plugs which commonly have a bulge around the ground prong, which may hinder insertion of the plug into an outlet receptacle framed by a standard opening in a wall plate cover such as the openings 216 and 316 in FIGS. 6 and 8, respectively.

Additionally, the electrical function 410 incorporated in the assembly 400 (also a night light as shown in FIG. 9) can be controlled by a sensor and/or switch 430. For example, the switch may enable the electrical function to be turned on or off as desired by a user, or may enable selection between an “always on” mode and a sensor mode which activates the night light when an amount of light less than a predetermined threshold is detected.

A further exemplary embodiment of the invention is shown in FIG. 10, in which the electrical function incorporated into the assembly 500 is an air freshener 510. Optionally, the air freshener can be controlled, e.g. turned on and off, via a switch 530. Similarly to the assembly 400 shown in FIG. 9, the opening 516 for a standard duplex outlet receptacle is enlarged by an indent 525 to accommodate the heavy duty type of plug as described above.

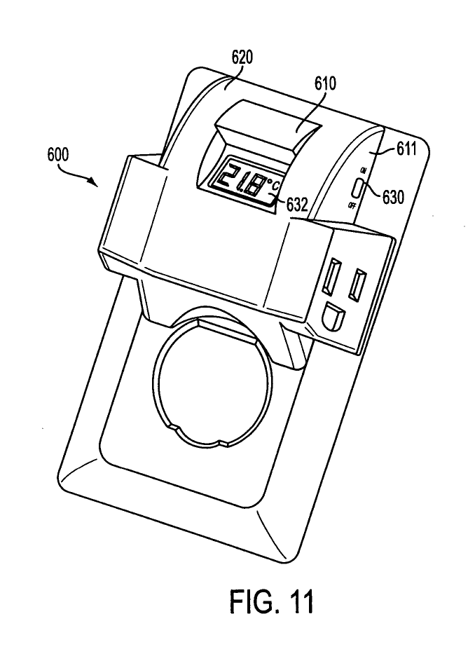

Still another exemplary embodiment of the invention is shown in FIG. 11, in which the electrical function incorporated into the assembly 600 is a thermometer 610. For example, a display panel in the upper portion 611 of the housing 620 can indicate the temperature of the room in which the assembly 600 is located. If desired, the thermometer 610 can also be turned on or off by a switch 630.

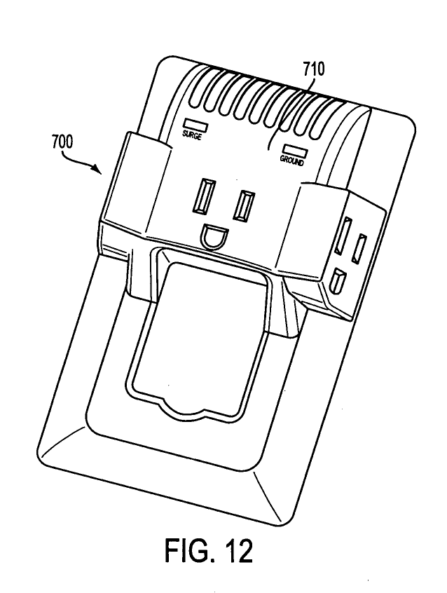

Yet another exemplary embodiment of the invention is shown in FIG. 12, in which the electrical function incorporated into the assembly 700 is a power control function, such as surge protector 710. In other variations of this embodiment, the integral electrical function may also include modem and/or coax connectors so that surge protection can be provided to different types of electronic equipment, a circuit breaker to protect the devices plugged into the plug receptacles provided on the assembly, and/or ADSL (Asymmetric DSL) protection during upload and download of data.

Other devices that could be powered by and incorporated into the inventive wall plate assembly may include alarms, air purifiers, timers, dimmers, emergency lighting, pest controls, home security and automation modules, etc. Additionally, various detectors such as smoke detectors, carbon monoxide detectors or motion sensors can be incorporated into the wall plate assembly according to the present invention.

Although most of the exemplary electrical functions discussed above are described herein as being incorporated in a wall plate assembly which can be fitted over and cover an existing wall plate, each of the electrical functions and outlet receptacle opening configurations can be incorporated into the wall plate assembly designed to be secured to the wall outlet in place of a standard wall plate.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A wall plate assembly comprising:
a wall plate body;
a set of male plug prongs extending from a back surface of the wall plate body;
an electrical function incorporated into the wall plate body, the electrical function configured to be electrically connected to the male plug prongs;
at least one plug receptacle electrically connected to the male plug prongs; and an opening formed in the wall plate body for accommodating an outlet receptacle of an electrical wall outlet, wherein the opening and the male plug prongs are aligned so that the plug prongs can be inserted into an upper outlet receptacle of a wall outlet while a lower outlet receptacle is exposed through and framed by the opening.

2. The wall plate assembly according to claim 1, wherein the electrical function is selected from the group consisting of a night light, an air freshener, an air purifier, a thermometer, a surge protector, a circuit breaker, an alarm, a timer, a dimmer, an emergency light, a pest control module, a security module, an automation module, smoke detector, a carbon monoxide detector, and a motion sensor.

3. The wall plate assembly according to claim 2, wherein the electrical function is a night light, and the night light is formed as an electroluminescent light.

4. The wall plate assembly according to claim 2, wherein the electrical function is a night light, and the night light is an LED light.

5. The wall plate assembly according to claim 2, wherein the electrical function is a night light, and the night light is a fluorescent light.

6. The wall plate assembly according to claim 2, wherein the electrical function is a night light, and the night light is an incandescent light.

7. The wall plate assembly according to claim 1, wherein further comprising a switch provided on the wall plate body and electrically connected to the electrical function for controlling the electrical function.

8. The wall plate assembly according to claim 1, wherein the opening accommodates an outlet receptacle of a standard duplex type of wall outlet.

9. The wall plate assembly according to claim 1, wherein the opening accommodates an outlet receptacle of a GFCI, decor, or modern type of wall outlet.

10. A wall plate assembly comprising:
a housing unit;
a frame formed around the housing unit and which is sized and shaped to cover a wall plate;
a set of male plug prongs extending from a back surface of the housing;
an electrical function incorporated into the housing unit, the electrical function configured to be electrically connected to the male plug prongs;
at least one plug receptacle electrically connected to the male plug prongs; and
an opening formed in the housing unit for accommodating an outlet receptacle of an electrical wall outlet, wherein the opening and the male plug prongs are aligned so that the plug prongs can be inserted into an upper outlet receptacle of a wall outlet while a lower outlet receptacle is exposed through and framed by the opening.

11. The wall plate assembly according to claim 10, wherein the electrical function is selected from the group consisting of a night light, an air freshener, an air purifier, a thermometer, a surge protector, a circuit breaker, an alarm, a timer, a dimmer, an emergency light, a pest control module, a security module, an automation module, smoke detector, a carbon monoxide detector, and a motion sensor.

12. The wall plate assembly according to claim 11, wherein the electrical function is a night light, and the night light is formed as an electroluminescent light.

13. The wall plate assembly according to claim 11, wherein the electrical function is a night light, and the night light is an LED light.

14. The wall plate assembly according to claim 11, wherein the electrical function is a night light, and the night light is a fluorescent light.

15. The wall plate assembly according to claim 11, wherein the electrical function is a night light, and the night light is an incandescent light.

16. The wall plate assembly according to claim 10, wherein further comprising a switch provided on the housing unit and electrically connected to the electrical function for controlling the electrical function.

17. The wall plate assembly according to claim 10, wherein the opening accommodates an outlet receptacle of a standard duplex type of wall outlet.

18. The wall plate assembly according to claim 10, wherein the opening accommodates an outlet receptacle of a GFCI, decor, or modern type of wall outlet.
